(19) United States
(12) Patent Application Publication
(10) Pub. No.: US 2016/0122038 A1
(43) Pub. Date: May 5, 2016

(54) OPTICALLY ASSISTED LANDING OF AUTONOMOUS UNMANNED AIRCRAFT

(71) Applicant: Singularity University, Moffett Field, CA (US)

(72) Inventors: Zachary Fleischman, San Francisco, CA (US); Chris Sullivan, San Francisco, CA (US)

(21) Appl. No.: 14/631,520

(22) Filed: Feb. 25, 2015

Related U.S. Application Data
(60) Provisional application No. 61/944,496, filed on Feb. 25, 2014.

(51) Int. Cl. B64F 1/20; G06T 7/00; B64F 1/00; B64D 47/08; B64D 47/04; H04B 1/3827; B64C 39/02

(52) U.S. Cl. CPC B64F 1/20; H04B 1/3827; G06T 7/0042; B64C 39/024; B64D 47/08; B64D 47/04; B64F 1/007; G06T 2207/30244; G06T 2207/30204; G06T 2207/10032; G06T 2207/10016; B64C 2201/18

(57) ABSTRACT

Systems, methods, apparatuses, and landing platforms are provided for visual and/or ground-based landing of unmanned aerial vehicles. The unmanned aerial vehicles may be capable of autonomously landing. Autonomous landings may be achieved by the unmanned air vehicles with the use of an imager and one or more optical markers on a landing platform. The optical markers may be rectilinear, monochromatic patterns that may be detected by a computing system on the unmanned aerial vehicle. Furthermore, the unmanned aerial vehicle may be able to automatically land by detecting one or more optical markers and calculating a relative location and/or orientation from the landing platform.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

This application claims a priority benefit under 35 U.S.C. §119(e) from U.S. Provisional Patent Application Ser. No. 61/944,496, filed on Feb. 25, 2014, which is hereby incorporated by reference in its entirety.

### BACKGROUND

Conventional methodology for the landing of vertical ascent/descent aircraft uses human piloting ability. Existing techniques for landing unmanned aerial vehicles use a satellite navigation system, optical instruments, in conjunction with an inertial navigation system, or combinations of these techniques. These solutions are less desirable for small-scale autonomous unmanned aircraft, for example, due to the mass of their implementation exceeding the lifting capacity of such aircraft. Furthermore, some solutions, such as using only satellite navigation system have a degree of inaccuracy that may not accommodate precision landing.

### SUMMARY

Certain embodiments of the present disclosure include methods, systems, and landing platforms for visual and/or ground-based landing of unmanned aerial vehicles. In particular, the visual and/or ground-based landing systems include optical markers to facilitate the landing of unmanned aerial vehicles.

In certain embodiments, the landing system comprises a landing platform. The landing platform may comprise first and second optical markers. The first optical marker may be larger than the second optical marker. The landing system may further comprise an unmanned aerial vehicle. The unmanned aerial vehicle may comprise an electronic camera and a hardware processor configured to execute computer-executable instructions. When executed, the computer-executable instructions may cause the hardware processor to access a first image captured by the electronic camera, wherein the first image is of the first optical marker. When further executed, the computer-executable instructions may cause the hardware processor to determine a first position of the unmanned aerial vehicle relative to the first optical marker based at least in part on the accessed first image. When further executed, the computer-executable instructions may cause the hardware processor to cause a change in altitude of the unmanned aerial vehicle based at least in part on the determined first position. When further executed, the computer-executable instructions may cause the hardware processor to access a second image captured by the electronic camera, wherein the second image is of the second optical marker. When further executed, the computer-executable instructions may cause the hardware processor to determine a second position of the unmanned aerial vehicle relative to the second optical marker based at least in part on the accessed second image. When further executed, the computer-executable instructions may cause the hardware processor to cause a further change in altitude of the unmanned aerial vehicle based at least in part on the determined second position.

In certain embodiments, a method for landing an unmanned aerial vehicle comprises accessing a first image, wherein the first image is of a first optical marker. The method may further comprise determining a first position of an unmanned aerial vehicle relative to the first optical marker based at least in part on the accessed first image. The method may further comprise providing first instructions to the unmanned aerial vehicle to change from the determined first position to a second position. The method may further comprise accessing a second image, wherein the second image is of a second optical marker, and wherein the second optical marker is a different size than the first optical marker. The method may further comprise determining a third position of the unmanned aerial vehicle relative to the second optical marker based at least in part on the accessed second image. The method may further comprise providing second instructions to the unmanned aerial vehicle to change from the determined third position to a fourth position.

In certain embodiments, the first position of the unmanned aerial vehicle is further determined based at least in part on using a 3D pose estimation algorithm, wherein input to the 3D pose estimation algorithm comprises data associated with the first image.

In certain embodiments, the unmanned aerial vehicle further comprises a light emitting device, wherein the light emitting device is capable of illuminating at least one of the first or second optical markers.

In certain embodiments, the method for landing an unmanned aerial vehicle may further comprise determining a relative position of the first optical marker with respect to the landing platform based at least in part on data encoded into the first optical marker.

In certain embodiments, the landing platform is foldable.

In certain embodiments, a landing platform comprises a landing area. The landing area may be capable of supporting one or more unmanned aerial vehicles. The landing platform may further comprise a first optical marker and a second optical marker, wherein the first optical marker is larger than the second optical marker. Each optical marker of the first and second optical markers may be detectable to enable a first unmanned aerial vehicle to determine its position relative to each respective optical marker of the first and second optical markers.

In certain embodiments, the landing platform further comprises a third optical marker, wherein the second optical marker is larger than the third optical marker, and wherein the third optical marker is detectable to enable the first unmanned aerial vehicle to determine its position relative to the third optical marker.

In certain embodiments, the first optical marker is encoded with information regarding the relative location of the first optical marker with reference to the landing platform.

In certain embodiments, at least one of the first or second optical markers comprises a rectilinear shape.

In certain embodiments, at least one of the first or second optical markers comprises a monochromatic color.

In certain embodiments, the marking area further comprises a printed surface.

In certain embodiments, the marking area further comprises the display of a user computing device. The user computing device may comprise a smartphone or a tablet.

In certain embodiments, the landing platform further comprises a light emitting device.

In certain embodiments, at least one of the first or second optical markers comprises a one unit first border, a two unit second border, and a five unit by five unit pattern.

### BRIEF DESCRIPTION OF THE DRAWINGS

The following drawings and the associated descriptions are provided to illustrate embodiments of the present disclosure and do not limit the scope of the claims.

FIG. 1 illustrates an example precision landing system, according to some embodiments of the present disclosure.

FIG. 2 is an example diagram representation of an unmanned aerial vehicle with an imager, according to some embodiments of the present disclosure.

FIG. 3A is an example representation of an imager and one or more light emitting devices, according to some embodiments of the present disclosure.

FIG. 3B illustrates an example configuration of a lighting apparatus on an unmanned autonomous aircraft, according to some embodiments of the present disclosure.

FIG. 4 illustrates example optical markers for a landing platform, according to some embodiments of the present disclosure.

FIG. 5 illustrates an example representation of optical marker portions on a landing platform as they may be detected by an imager at different altitudes, according to some embodiments of the present disclosure.

FIG. 6A illustrates an example diagram of a method for folding a landing platform, according to some embodiments of the present disclosure.

FIG. 6B illustrates an example representation of a landing platform with folding lines, according to some embodiments of the present disclosure.

FIG. 7 is a flowchart illustrating an example autonomous landing process, according to some embodiments of the present disclosure.

FIG. 8A is an example representation of a ground-based lighting system for automated visual landings, according to some embodiments of the present disclosure.

FIG. 8B is another example representation of a ground-based lighting system for automated visual landings, according to some embodiments of the present disclosure.

FIG. 9A is a diagram illustrating a networking environment with which certain embodiments discussed herein may be implemented.

FIG. 9B is a diagram illustrating a computing system with which certain embodiments discussed herein may be implemented.

### DETAILED DESCRIPTION

Various aspects of the disclosure will now be described with regard to certain examples and embodiments. They are intended to illustrate but not to limit the disclosure. Nothing in this disclosure is intended to imply that any particular feature or characteristic of the disclosed embodiments is essential. The scope of protection is defined by the claims that follow this description and not by any particular embodiment described herein.

Due to the ever-increasing growth of highly developed areas, such as cities, or the continually growing needs of undeveloped regions, such as isolated rural areas, there is a need for efficient transportation and/or deliveries. Transportation of goods via unmanned aerial vehicles may help satisfy these needs. However, the inventors have found existing technologies and techniques inadequate for autonomously landing unmanned aerial vehicles. For example, unmanned aerial vehicles may use Global Positioning System (GPS) to locate and fly to a destination defined by its coordinates. However, navigation via global positioning may be inaccurate by up to several meters, which may be inadequate to autonomously land an unmanned aerial vehicle in various environments. For example, the surface terrain may be uneven or be near property or other geographic boundaries. Thus, there is a need for a low-cost, efficient, and/or lightweight solution for autonomous landing of unmanned aerial vehicles.

Generally described, aspects of the present disclosure relate to systems and methods for autonomous landing of autonomous and/or remotely piloted unmanned aerial vehicles (UAV). In particular, the present disclosure describes the following components and/or techniques: autonomous electronic flying vehicles with imagers on the vehicles, a station and/or landing platform, ground-based optical markers, portable and/or foldable landing platforms, and/or light emitting devices for autonomous visual landings. For example, according to some embodiments, a UAV may be provided destination coordinates in a global positioning format and/or Global Positioning System (GPS) format. The UAV can navigate to the destination using GPS navigation, operator controlled flight, or other navigation techniques. Once at the destination, the UAV may switch from a more general navigation modality and/or state to a hybrid navigation modality where the UAV incorporates ground-relative navigation. For example, in some embodiments, the UAV includes an imager and/or a device for recording images to identify optical markers on the ground. The imager can be a number of different devices including, without limitation, a camera, imaging array, machine vision, a video camera, image sensor, charged-coupled device (CCD), a complementary metal oxide silicon (CMOS) camera, etc., or any similar device. The imager can be greyscale, color, infrared, ultraviolet, or other suitable configuration. In certain embodiments, the UAV can dynamically process the optical markers and/or images on the ground to infer its relative position in three-dimensional space. The UAV can use these optical markers and images of the markers to adjust its position. For example, upon detecting the relative size and/or position of one or more optical markers, the UAV can adjust its altitude or relative position by moving and taking subsequent images for further analyzing. In some embodiments, the UAV can adjust its altitude or relative position by comparing subsequent images to previous images. Moreover, unique optical markers and/or images can be configured to be of relative sizes and/or scaled such that as the UAV descends it can optically detect the relative sizes of optical markers and/or images as they come into the imager's field of view. Through processing the series of images or based on single images, the UAV can therefore detect its position relative to the landing position. Thus, the systems and methods described herein provide a low-cost and/or efficient solution to autonomously land a UAV. Alternatively, optical markers could be used as way points, location information, or other navigational aids that can assist in the autonomous flight of a UAV. For example, the UAV could use optical markers to compensate for changing environmental conditions such as wind speeds or sudden gusts, or for disrupted communication with GPS or other guidance systems.

As used herein, in addition to having its ordinary meaning, an “optical marker” refers to a visual-based cue that may be used as a point of reference to determine a relative position, location, orientation, and/or measurement. Optical markers may be rectilinear and/or may have other shapes such as circles and/or curves. Optical markers may comprise patterns, shapes, colors, and/or or other features sufficient to identify their location to a UAV. Optical markers may be printed in monochromatic tones, colors, and/or black and white. Furthermore, optical markers may include reflective and/or retroreflective materials or light emitting devices. The light emitting devices may emit light in non-visible portions of the spectrum, such as ultraviolet or infrared to make them less intrusive or more effective. In some embodiments, optical markers may be uniquely identifiable by their shape patterns and/or optical markers may be associated with metadata, such as the dimensions of the particular optical markers, as further described herein.

### Precision Landing System

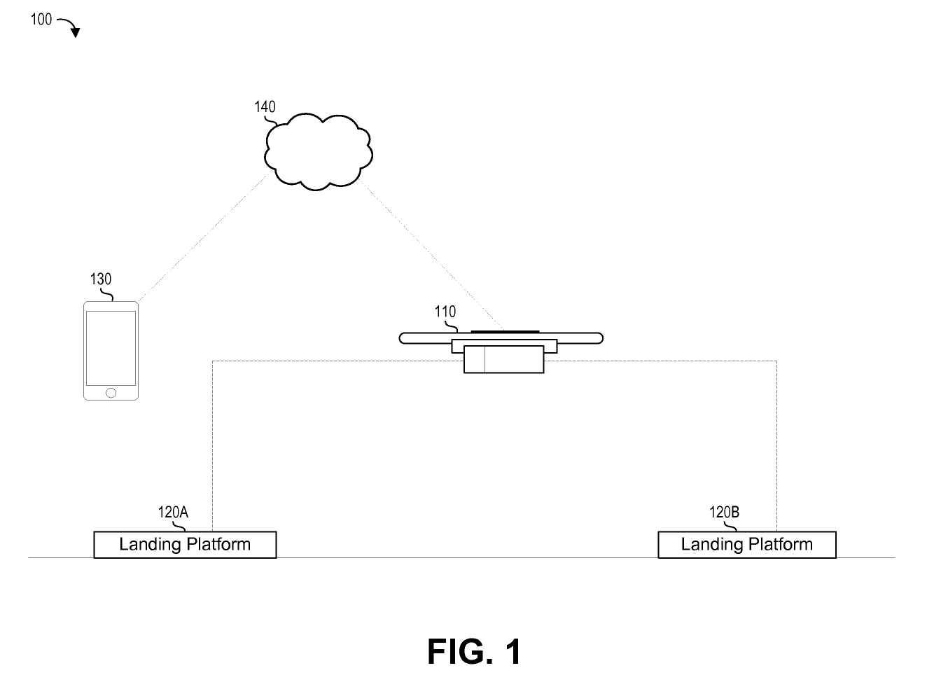

FIG. 1 illustrates an example precision landing system, according to some embodiments of the present disclosure. Precision landing system 100 is comprised of one or more unmanned aerial vehicles 110, landing pads and/or platforms 120A-120B, a mobile application and/or user computing device 130, and a navigation system and network 140. Precision landing system 100 may also be referred to as an unmanned, ground-based, and/or marker-based landing system.

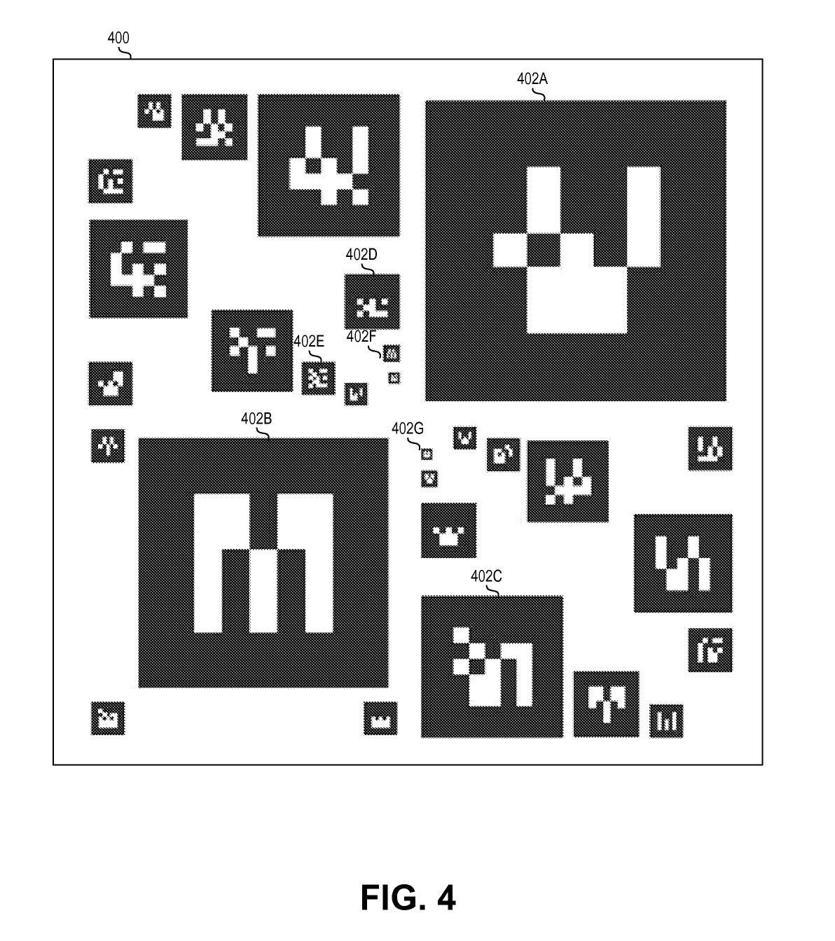

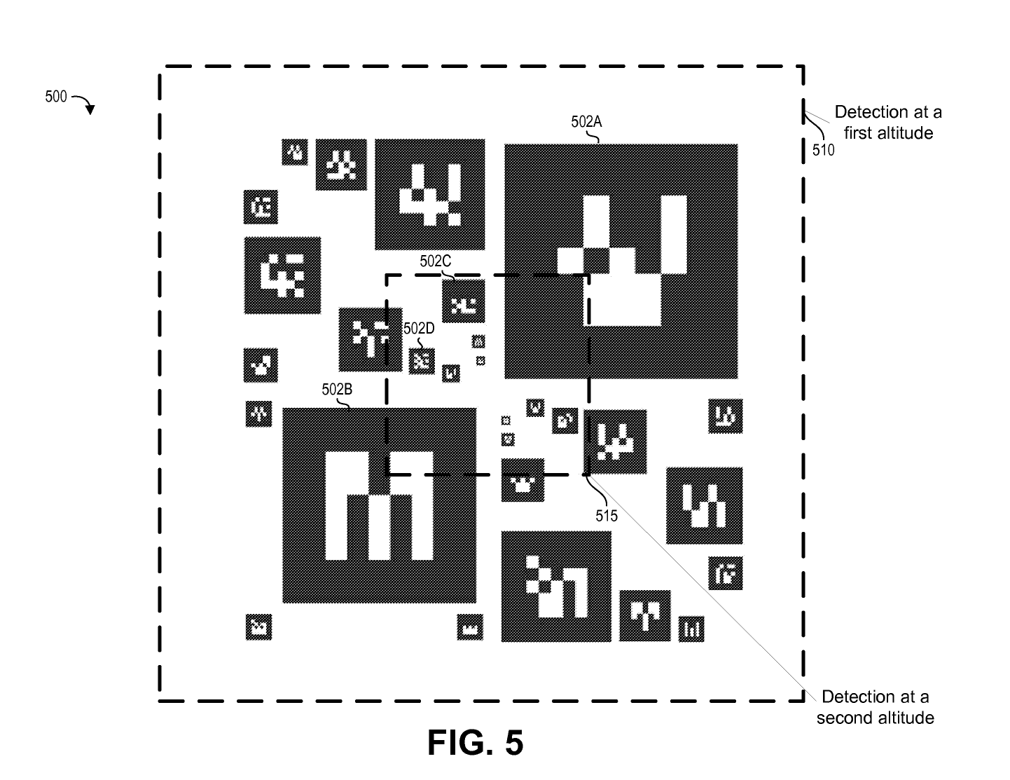

Precision landing system 100 can be used to guide UAV 110 to the desired landing pad and/or platform. For example, in some embodiments, the UAV 110 may be capable of transporting a package from landing pad 120A to landing pad 120B and/or vice versa. Landing platforms 120A and 120B include a landing area capable of supporting one or more UAVs. Landing platforms 120A and 120B can also include a marking area, which is described in further detail with respect to FIGS. 4 and 5. In some embodiments, the navigation and/or control of UAV 110 may be initiated via user computing device 130. In other embodiments, user computing device 130 is optional in precision landing system 100 and may not be used. UAV 110 can communicate with navigation system and network 140 to request and/or receive an authorized route. UAV 110 can then fly the authorized route.

In some embodiments, UAV 110 can be configured to communicate wirelessly with the navigation system and network 140. The communication can establish data link channels between different system components used, for example, for navigation, localization, data transmission, or the like. The wireless communication via network 140 can be any suitable communication medium, including, for example, cellular, packet radio, GSM, GPRS, CDMA, WiFi, satellite, radio, RF, radio modems, ZigBee, XBee, XRF, XTend, Bluetooth, WPAN, line of sight, satellite relay, or any other wireless data link.

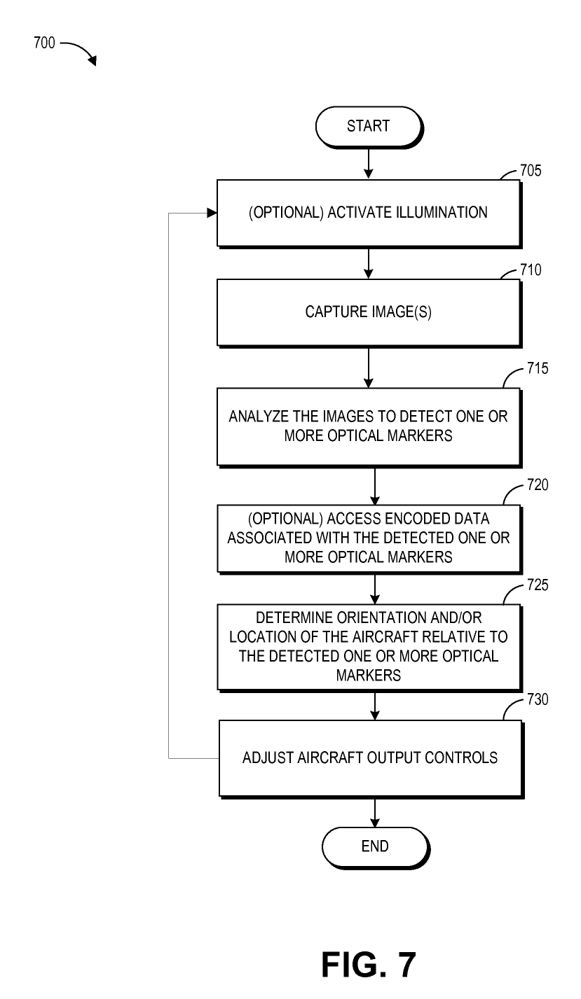

Once within a predetermined range of and/or above destination 120B, UAV 110 can switch to a ground relative modality and execute a visual landing process, such as process 700 of FIG. 7. As described herein, UAV 110 may use an imager to optically recognize one or more unique optical markers to execute precision landing. Thus, UAV 110 can land at landing pad 120B using the techniques described herein.

Additional details regarding the components of system 100 will be described below.

### Unmanned Aerial Vehicles

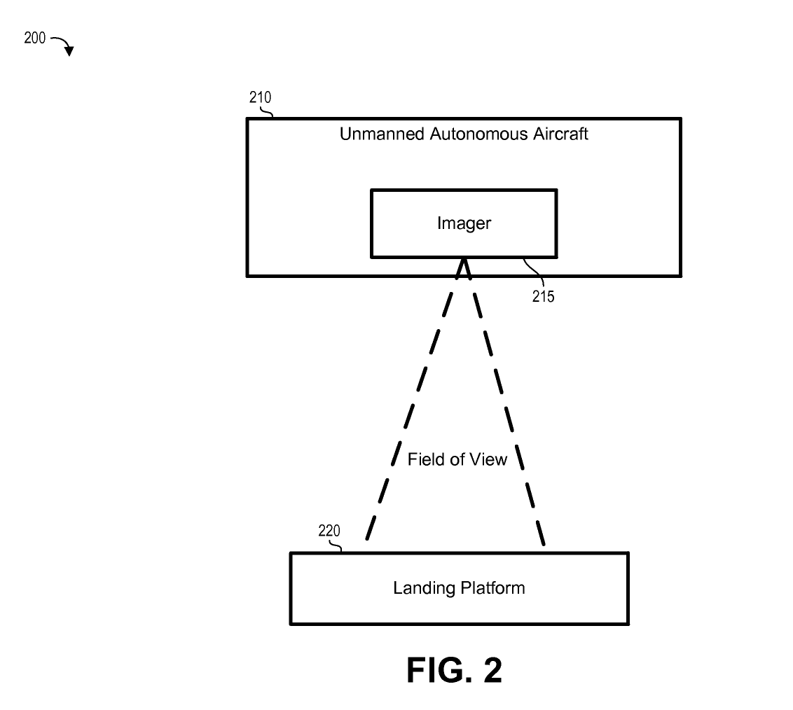

FIG. 2 is an example diagram representation of a UAV with an imager, according to some embodiments of the present disclosure. Landing environment 200 includes one or more UAVs 210 with an imager 215 and one or more stations and/or landing platforms 220. An imager may be an electronic device that records images, such as, but not limited to, an electronic camera, imaging array, machine vision, a video camera, image sensor, charged-coupled device (CCD), a complementary metal oxide silicon (CMOS) camera, etc., or any similar device.

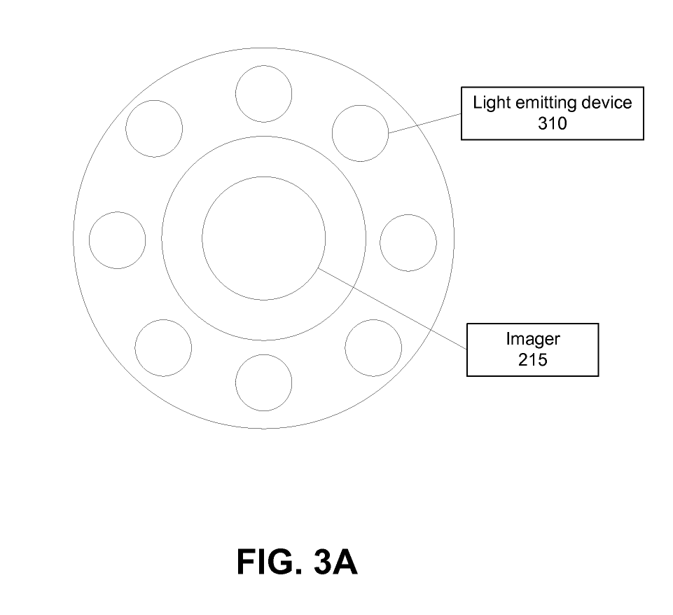

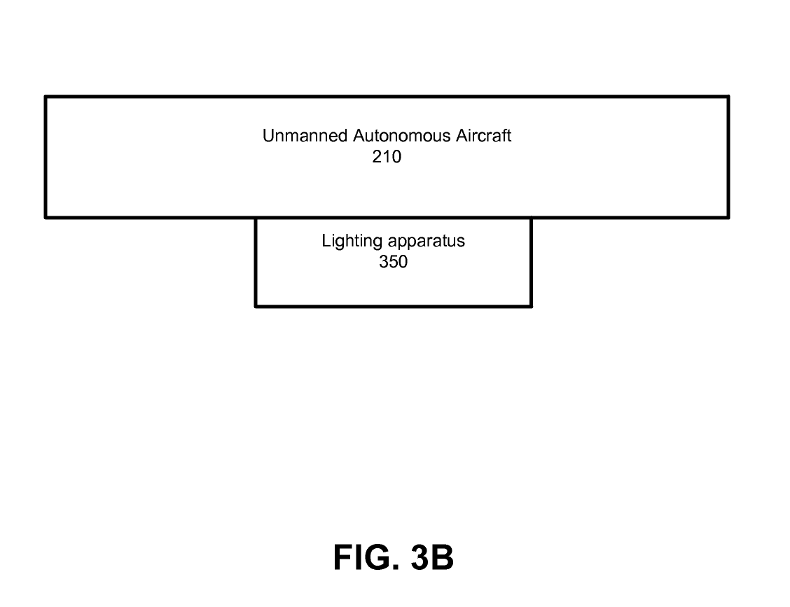

As illustrated in FIG. 1, as UAV 210 approaches landing platform 220, imager 215 may capture images of landing platform 220 within the imager's field of view and/or focal length at a particular altitude. In certain embodiments, the imager's focal length is fixed, however, in other embodiments, the focal length is adjustable, such as in a zoom lens. In some embodiments, there may be predetermined altitude to begin attempting to detect landing platform 220 with imager 215. For example, a predetermined altitude to begin visual landing detection may be computed and/or determined based on the maximum image marker size, imager resolution, and the imager field of view. In other embodiments, the altitude for beginning visual landing detection may be dynamic based upon changing conditions, such as the loss of communication with a control system, change in weather, UAV component failure, authorized route cancellation, or other condition that makes a dynamic visual landing detection appropriate. Generally, the imager's field of view and resolution may determine the altitude from which the pixels of the largest image marker can be detected by imager 215. Thus, UAV 210 may initiate visual landing at the determined altitude because the imager will be able to capture images of the largest image marker. Image markers are described in further detail herein with respect to FIGS. 3 and 4.

Example predetermined altitudes and/or imagers to begin visual landing may include the following. In some embodiments, a predetermined altitude to begin visual landing may be in excess of five meters in altitude for an imager of 5 megapixel resolution and a field of view of 60°+/−15°. For example, UAV 210 may begin visual landing at approximately 12 meters+/−3 meters for a 5 megapixel imager with a field of view of 60°+/−15°. In embodiments with an imager with more resolution, the visual landing may be initiated at higher altitudes. Alternatively, platform 220 can include larger markers to permit detection at higher altitudes. In other embodiments, platform can comprise additional features, such as light emitting devices or reflective surfaces that can aid in detection at altitudes different from those that may be detected based upon the marker patterns alone. In some embodiments, imager 215 may be used with a fixed field of view non-magnifying optics with infinity focus. For higher altitudes, a larger imager resolution and/or increased field of view size may be used to capture the appropriate image marker pixel density.

In some embodiments, imager 215 may be a low-cost camera. For example, imager 215 may be a three or five megapixel camera. The camera can be a general purpose device that is available off-the-shelf. In other embodiments, imager 215 may be a special-purpose camera configured to achieve a maximum field of view and/or allow the visual landing process to begin at a higher altitude.

In addition to the imager and optics 215 of UAV 210, UAV 210 includes a computing device and/or system that controls its flight operations. The on-board computing device and/or system of UAV 210 may include central processing unit, non-transitory computer-readable media and/or memory, graphics processing unit, field programmable gate array, microprocessor, and/or aircraft flight controller. The computing system may access captured data from imager 215, process the data in real- or near-time to infer position and/or orientation relative to landing platform 220, then develops control outputs to send to a flight controller—an electronic logic processor and motor control apparatus—to initiate relative guidance corrections for landing, which is described in further detail herein. Alternatively, the UAV can send data from its imager 215 to be processed elsewhere. For example, data from imager 215 can be processed by a remote device. The remote device can process the data to provide precision landing information to UAV 210 or to provide route information, such as offset from GPS position, to other devices or controllers on a network.

FIGS. 3A-3B are example representations of an imager and a UAV with corresponding lighting devices, according to some embodiments of the present disclosure. Low-light conditions, such as, for example, cloud coverage, night time, early morning, rain, snow, or other low-light conditions may cause difficulties for autonomous visual landing of UAVs. Thus, a UAV may operate in low-light conditions by using lighting devices on the UAV to illuminate the landing platform to facilitate detection of the optical markers on the landing platform or for other landing techniques described herein. As illustrated in FIG. 3A, imager 215 may be used in conjunction with one or more light emitting devices 310. Example light emitting devices 310 may include high intensity light emitting diodes. When the UAV initiates automated visual landing, light emitting devices 310 may illuminate the landing platform and/or the optical markers to assist in visual detection by imager 215. As illustrated in FIG. 3B, lighting apparatus 350 may be attached to the bottom of UAV 210. Alternatively, lighting apparatus 350 may be attached to UAV 210 so that it can provide light to illuminate the landing platform without being located on the bottom of the UAV 210. For example, the lighting apparatus 350 can be attached to the sides of the UAV 210. In certain embodiments, the lighting apparatus 350 is removably attached to the UAV 210. In some embodiments, the lighting apparatus 350 can be attached to or located near the landing platform either for storage or to provide illumination to the landing platform directly.

### Landing Platforms

As shown in FIGS. 1 and 2, the UAV system can include station platforms and/or landing platforms. These landing platforms can provide a location for one or more UAVs to make a precision landing, or provide additional information such as route guidance. According to some embodiments of the present disclosure, landing platforms may include optical markers to facilitate computer recognition of the landing platform and/or assist with automated visual landing.

FIG. 4 illustrates an example of the optical markers that can be placed on the landing platform, according to some embodiments of the present disclosure. The landing platform can have a marking area 400 that includes one or more optical markers 402A-402G. For example, in certain embodiments the landing platform can be a flat surface with the marking area 400. This can be a relocatable area such as, for example, a printed surface. For example, a printed surface can include a printed piece of paper, which may be moved. In certain embodiments, a user can print a marking area 400 onto a piece of paper to create a landing platform. In some embodiments, optical markers 402A-402G are printed onto a surface of landing platform. In some embodiments, marking area 400 can comprise a reusable surface that is adhesively applied to a landing platform, such as, for example, a sticker. In some embodiments, marking area 400 can comprise the surface of a user computing device, such as, for example a smartphone or tablet.

Optical markers 402A-402G can be designed to be recognized by a UAV's imager and its computing system. Moreover, optical markers 402A-402G may be configured and/or generated such that their patterns and/or shapes are unlikely to be present and/or found in the general environment. In some embodiments, optical markers 402A-402G may be rectilinear in shape of varying scaled sizes. Rectilinear optical markers may be advantageous because edge detection by computer vision techniques may be more accurate with ninety degree angles. Alternatively or additionally, other shapes and/or patterns may be used for optical markers (other than rectilinear shapes) so long as the shapes and/or patterns are detectable by the UAV computing system. For example, the optical markers may be similar to fiducial markers used in other machine vision systems and/or augmented reality systems. The optical markers can include encoding that allows, for example, a UAV to recognize a specific landing platform or a type of landing platform. In certain embodiments, the landing platform includes an identifier to help a UAV determine the identity of the landing platform.

In some embodiments, the difference in scale and/or relative size of optical markers 402A-402G facilitates optical detection by the UAV at varying altitudes. For example, the imager may be able to discern the relative scale of different optical markers 402A-402G. For example, optical marker 402A may be scaled larger than optical marker 402B; optical marker 402B may be scaled larger than optical marker 402C; optical marker 402C may be scaled larger than optical marker 402D, etc. One or more optical markers 402A-402G therefore may be detectable at varying altitudes. In some embodiments, landing platform's marking area 400 may be configured such that two or more optical markers are detectable at a particular altitude. For example, optical markers 402A and 402B, among others, may be detectable at a first altitude, and optical markers 402D and 402G, among others, may be detectable at a second altitude based at least on the respective relative sizes of the optical markers. In some embodiments, at least four optical markers may be of similar sizes to be detectable at a particular altitude. In certain embodiments, optical markers 402A-402G may be scale invariant. In other words, the shape of optical markers 402A-402G may not change so long as the optical maker is within the field of view and/or focal length of the imager. In certain embodiments, the imager has a fixed focal length and the relative size of the optical marker provides an indication of location or altitude. Further detail regarding detection of optical markers by the UAV computing system is described herein with respect to FIG. 5.

In some embodiments, the landing platform's marking area 400 and/or optical markers 402A-402G may be composed of reflective and/or retroreflective material. The reflective material may facilitate and/or increase the accuracy of computer visual detection by the UAV computing system. In certain embodiments, the colors used in the optical markers 402A-402G may be of high monochromatic contrast and/or use an optically “flat black” with a reflective and/or retroreflective “white.” Retroreflective materials may have enhanced reflectivity from point light sources where this reflectivity decays non-linearly with increasing incidence angle outside of ninety degrees, i.e., the zenith projection. Maximum reflectivity may be accomplished by placing the imager proximal to the origin of the point source light. An example imager proximal to an origin source of light may be imager 215 of FIG. 3A. In some embodiments, reflective materials may have enhanced detectability over retroreflective materials in off angle (from the zenith projection) detection and/or low-lighting conditions. These features can be used to help determine the location of the landing platform with greater precision.

In some embodiments, optical markers 402A-402G are generated based on a pattern generation algorithm. For example, rectilinear optical markers may include a one unit white border inscribed by a two unit black border, which contains a centered five unit by five unit black and white pattern. This example format for rectilinear optical markers may have unique patterns that are created by a marker generator. In an embodiment, the optical markers have up to 2²⁵ unique patterns. The unique patterns of optical markers 402A-402G may be known, determined, and/or accessible by the UAV computing system. In some embodiments, optical markers 402A-402G may encode information. For example, optical marker 402A (and/or other optical markers optical markers 402B-402G) may encode information about its respective location from the center of landing platform 400. Additionally or alternatively, optical markers may encode information about the respective dimension of the optical marker, such as 5 cm×5 cm or 10 mm×10 mm, for example.

FIG. 5 illustrates an example representation of the portions of a marking area 500 of a landing platform as it is detected by a UAV's imager at various altitudes, according to some embodiments of the present disclosure. Landing platform's marking area 500 may include optical markers 502A-502D. Landing platform marking area 500 and optical markers 502A-502D may be similar to landing platform 400 and optical markers 402A-402G of FIG. 4, respectively.

Example areas 510 and 515 may illustrate the portions of landing platform 500 that are detectable by the UAV imager and/or UAV computing system at various altitudes. For example, first area 510 may be detectable by the UAV imager at a first altitude, such as eight meters. The UAV computing system may be able to detect one or more optical markers at the first altitude based on the resolution, field of view, and/or focal length of the imager. For example, the UAV computing system may detect optical markers 502A and 502B at the first altitude. The UAV computing system may infer its relative position in three dimensional space based at least on the detection of optical markers 502A and 502B and active and/or proceed with its descent, which is described in further detail herein. While descending, second area 515 may indicate the area of landing platform 500 that is detectable at a second altitude. Thus, the UAV computing system may be able to detect optical markers 502C and 502D, similar to the detection of optical markers 502A and 502B, to continue its controlled descent of the UAV.

As described herein, based on the particular of imager and/or one or more lighting devices, the UAV imager and/or computing system may be unable to detect particular optical markers at different altitudes. For example, the optical markers detectable at an altitude of ten meters may be different than the optical markers at an altitude of one meter. Thus, landing platform 500 may be configured to include optical markers of various sizes such that the minimum pixel density necessary for optical detection is maintained throughout the controlled descent. The pixel density of optical markers of landing platform 500 may increase and/or decrease as a function of the altitude of the UAV according to a sine function. In some embodiments, the largest optical markers may be placed towards the outside of landing platform 500 and the smaller optical markers may be placed towards the center of the landing platform 500 since the UAV's imager may be centrally located on the UAV. In some embodiments, the use of multi-scale optical markers enable fixed field-of-view and fixed focal length imagers and/or optics, which may substantially reduce the complexity or cost of components, increase the accuracy of detecting the landing platform, and/or increase the durability of the UAV.

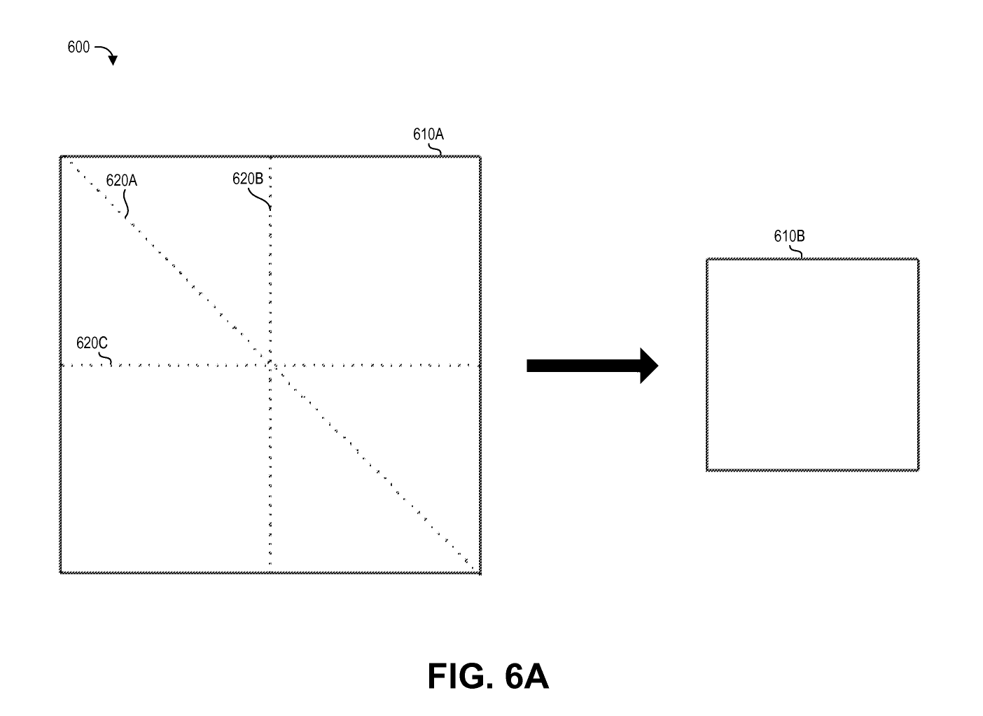

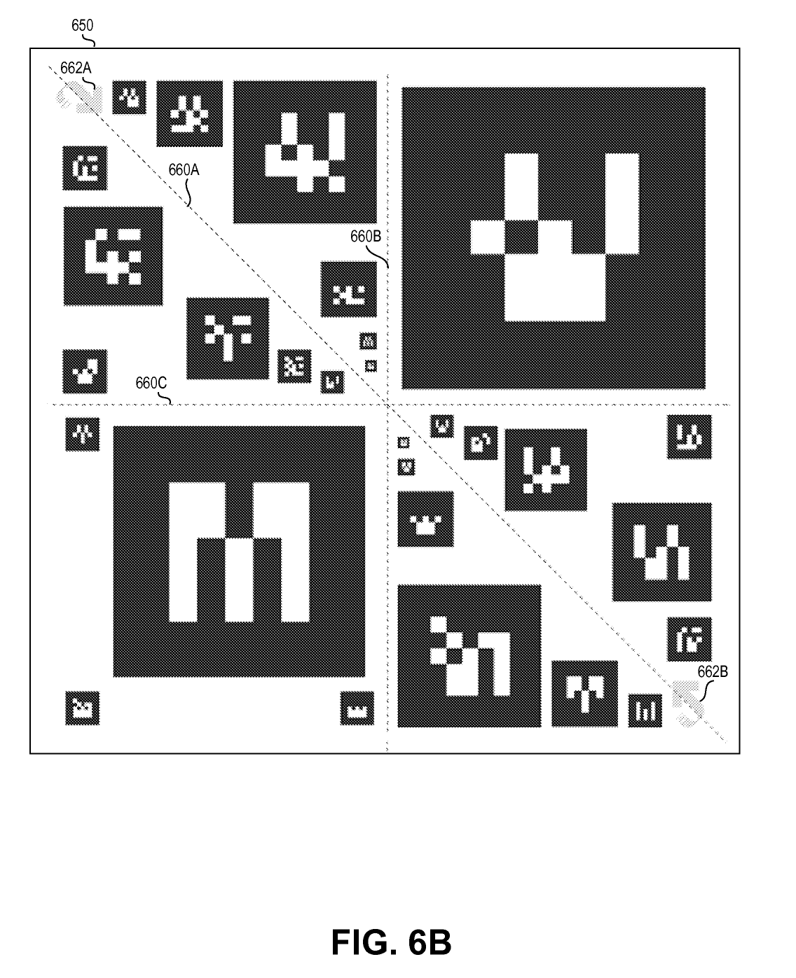

FIG. 6A illustrates an example method for folding a landing platform, according to some embodiments of the present disclosure. Landing pad 610A includes folding lines 620A-620C. Folding lines 620A-620C may allow landing pad 610A to be folded to one quarter of its original area as illustrated by folded landing pad 610B. Advantages of this folding structure include minimizing the package area of landing pad 610A, permitting easier transportation of folded landing platform 610B (such as a human being carrying folded landing platform 610B with a single hand or under an arm while standing or walking), and/or strategic placement of folding lines 620A-620C to avoid intersection with one or more optical markers, which will be described in further detail with respect to FIG. 6B.

Folding lines 620B and 620C may bisect each side of landing platform 610A to divide landing platform 610A into four quadrants. Folding line 620A may diagonally bisect landing platform 610A. Example method 600 of folding landing platform 610A may include folding the top left corner and the bottom right corner inwards to the center of landing platform 610A. Using this example folding method and/or as illustrated by folded landing platform 610B, the upper right quadrant may fold directly on top of the bottom left quadrant of landing platform 610A and the upper left quadrant and the bottom right quadrant may form isosceles triangles from folding line 620A.

In some embodiments, there may be variations of the folding method and/or the folding lines of the landing platform. For example, a landing platform may include fold lines 620B and 620C, but may exclude folding line 620A. A corresponding folding method may include 1) folding the landing platform on folding line 620B to bisect the landing platform; and 2) further folding the landing platform on folding line 620C to further bisect the landing platform. Thus, the resulting folded landing platform may appear similar to folded landing platform 610B.

FIG. 6B illustrates an example representation of a landing platform with folding lines, according to some embodiments of the present disclosure. Landing platform 650 may be similar to landing platform 610A of FIG. 6A, except that landing platform 650 includes representations of optical markers. As illustrated, folding lines 660A-660C may not intersect optical markers of landing platform 650. The placement of folding lines to avoid intersection of optical markers may be advantageous to preserve the detectability of the optical markers by a UAV computing vision system. For example, if an optical marker was intersected by a folding line, the printed, reflective, and/or retroreflective material of the optical marker may be distorted and/or become distorted over time. Such distortion of the optical markers may interfere with the detectability of the optical markers by a UAV computing vision system. As previously mentioned and as illustrated by representative arrows 662A and 662B, folding of the bottom right and top left corners of landing platform 650 may result in a folded landing platform, such as folded landing platform 610B of FIG. 6A.

### Visual Landing Processes

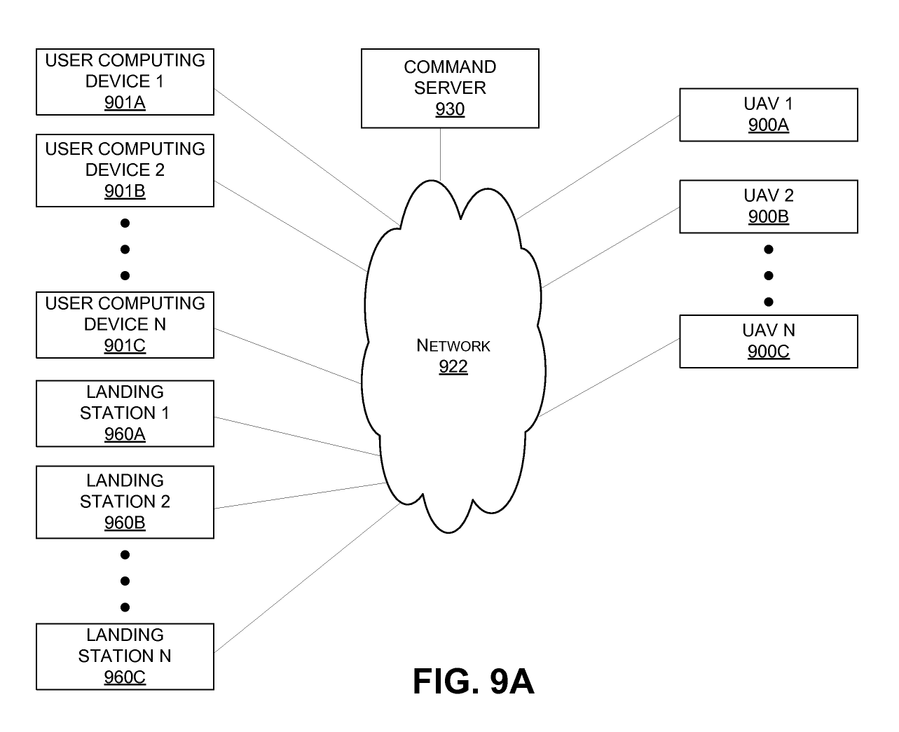

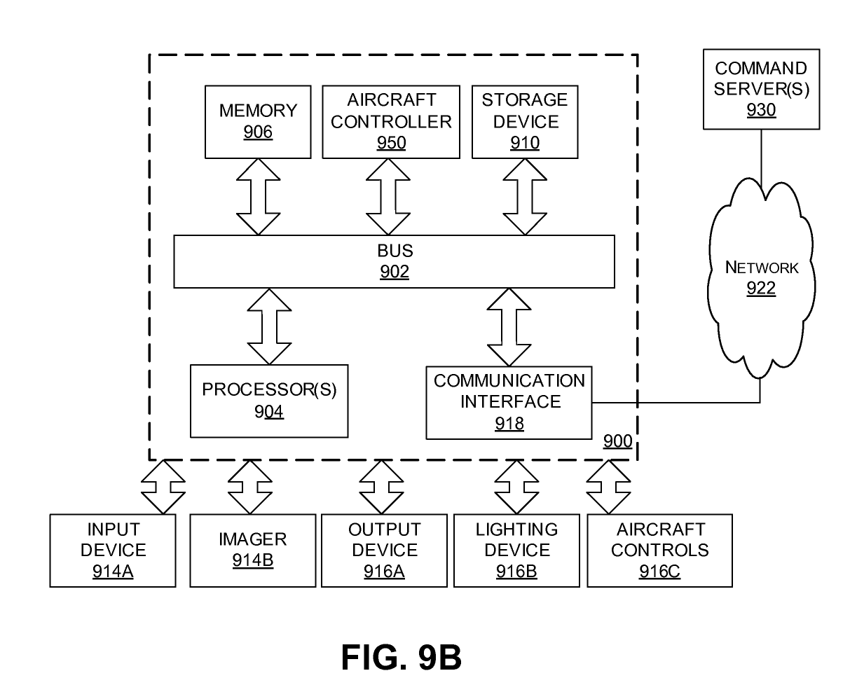

FIG. 7 is a flowchart illustrating an example automated visual landing process 700, according to some embodiments of the present disclosure. Example method 700 may be performed by a UAV computing system, such as computing system 900 of FIG. 9B, which is described in further detail herein. Visual landing can be performed by any of the systems and/or processors described herein. For convenience, the remainder of this disclosure will refer visual landing process 700 as being implemented by a UAV computing system, although it should be understood that these shorthand references can refer to any of the systems or subsystems described herein. As previously mentioned, the UAV computing system may initiate the visual landing process 700 when the UAV has reached the destination as specified by global positioning navigation. Depending on the embodiment, method 700 may include fewer or additional blocks and/or the blocks may be performed in an order different than is illustrated.

Beginning at block 705, UAV computing system may optionally activate illumination. As previously described, a UAV may operate in low-light conditions and active illumination of the ground may facilitate automated visual landing and/or detection of the optical markers. For example, UAV computing system may activate the one or more light emitting devices 310 of FIG. 3A and/or lighting apparatus 350 of FIG. 3B on the UAV. In some embodiments, UAV computing system may be configured to activate illumination at a predetermined and/or configurable time of day. Alternatively or additionally, UAV computing system may be configured to activate illumination based on environmental conditions. For example, one or more input sensors and/or the captured images described below may indicate that the environmental lighting conditions and/or luminosity of the physical environment is insufficient for successful visual landing. Thus, UAV computing system may activate illumination based on input data indicative of the environmental lighting conditions. In certain embodiments, the UAV computing system can activate illumination on the landing platform. The illumination on the landing platform can be in addition to the lighting on the UAV or independent of the lighting on the UAV.

At block 710, UAV computing system captures one or more images. UAV computing system may capture one or more images via imager 215 of FIG. 2. In some embodiments, the imager may capture one or more images with a rolling shutter, progressive scan, and or global shutter. The particular imager setting and/or type may be configured to minimize image captures of moving objects and/or to reduce image blur. In certain embodiments, the image captured by the imager 215 includes all or a portion of marking area, as previously described with respect to FIG. 5.

At block 715, UAV computing system analyzes the one or more captured images to detect one or more optical markers. In some embodiments, the UAV computing system may initiate one or more image preprocessing steps to facilitate the detection of one or more optical markers. For example, the one or more captured images may be compressed or decompressed using one or more known image compression or decompression techniques. UAV computing system may execute a monochromatic conversion of the one or more images to obtain black and white versions of the images. The UAV computing system may further pass the one or more images through a contrast, and/or sharpness filter or other image processing algorithms to enhance the detection of the markers, reduce the size of the image, reduce noise, or for other reasons advantageous to additional image processing.

UAV computing system may execute one or more algorithms to detect the optical markers. For example, UAV computing system may analyze an image of one or more optical markers, such as optical marker 402A of FIG. 4. UAV computing system may recognize an optical marker by using an edge detection algorithm, such as a Canny edge detection algorithm. In some embodiments, the edge detection algorithm may recognize the edges of optical marker 402A because optical marker 402A may have white and black borders. A Canny edge detection algorithm may have the following steps: apply a Gaussian filter to smooth the image and/or to remove noise, locate the intensity gradients of the image, apply non-maximum suppression, apply double thresholds to determine potential edges, and/or track edges by hysteresis, which may finalize the detection of edges by suppressing all other edges that are weak and not connected to strong edges.

In some embodiments, an edge detection algorithm, as executed by the UAV computing system, may further determine whether two edges that meet at a vertex correspond to the edges of an optical marker by comparing the edges to a known format for optical markers and/or a database of optical markers. The edge detection algorithm may further evaluate whether proximal pixels to the determined edge constitute a black border, such as a 2 unit×2 unit black border, which may be illustrated by optical marker 402A. Additional steps in the edge detection algorithm may include detection of a parallelogram and/or rectangular shape. A determination of whether an optical marker is detected in the image may be based on a detected pattern within the optical marker. For example, optical marker 402A may include a unique 5 unit×5 unit black and white pattern. In some embodiments, UAV computing system may access a data store to determine the presence of a known unique pattern. In other embodiments, the UAV computing system may use a dynamic algorithm to determine whether a pattern in the image corresponds to an approved and/or accepted unique pattern.

In some embodiments, UAV computing system may use one or more computer, visual, and/or optical recognition techniques to additionally or alternatively analyze the image or portions of one or more images to detect the optical markers. In some embodiments, a computer located on the UAV performs Canny edge detection. In other embodiments, a computer not located on the UAV performs Canny edge detection. The UAV computing system may further use one or more techniques known in the art of fiducial marker detection to detect optical markers. Fiducial marker detection is known to those skilled in the art of machine vision, for example. These techniques can be used, for example, to detect optical markers that are not rectilinear.

At block 720, UAV computing system may optionally access encoded data associated with the detected one or more optical markers. For example, specific and/or particular optical markers may encode data about their respective location relative to the landing platform. Alternatively or additionally, specific and/or particular optical markers may be associated with relative location data. In some embodiments, UAV computing system may be able to query and/or retrieve the relative location of the optical marker based on the unique pattern for each optical marker. Other data that may be encoded and/or accessible based on a detection of an optical marker may be a known and/or stored dimension of the optical marker. As described herein, the position and/or orientation algorithm used to determine the relative position and/or orientation of the UAV may use the accessed dimension of the one or more detected optical markers.

In some embodiments, other data may be encoded and/or associated with the optical markers. For example, the optical markers may encode information identifying the particular landing platform and/or other metadata associated with the landing platform. Furthermore, particular optical markers may cause the UAV computing system to execute conditional subroutines, such as routines for sending custom communications to a command navigation system based on particular optical markers that are detected.

At block 725, UAV computing system determines the orientation and/or location of the UAV relative to the detected one or more optical markers. UAV computing system may use one or more algorithms and/or techniques to determine a three-dimensional position within space based on the detected one or more optical markers, such as, but not limited to a 3D pose estimation algorithm or other known algorithms in the field of computer vision or augmented reality. The pose of an object may refer to an object's position and orientation relative to a coordinate system. Example 3D pose estimation algorithms that may be used include iterative pose algorithms and/or a coplanar POSIT algorithm. The known and/or accessed dimension of the optical marker and/or the detected position of the optical marker relative to a coordinate system (based on the captured image) may be used as inputs to the 3D pose estimation algorithm to determine the pose of the optical marker and the relative distance and/or position of the UAV from the optical marker. The detection of a single optical marker at a particular altitude by UAV computing system may be sufficient to resolve the UAV's relative position and/or orientation from the optical marker and/or landing pad. In some embodiments, the relative location of the UAV may be further complemented by encoding information associated with particular optical markers indicating the optical marker's location relative to the center of the landing platform. In some embodiments, if multiple optical markers are detected at a particular altitude, then the UAV computing system may execute one or more positioning algorithms, such as the 3D pose estimation algorithm, for each optical marker of the detected multiple optical markers to further improve the accuracy and/or robustness of the visual landing.

At block 730, UAV computing system may adjust output controls on the UAV during controlled flight. The UAV computing system may use the determined orientation and/or position of the UAV to determine corresponding outputs to control the UAV's flight and/or descent. For example, one or more propellers and/or speed controllers may be controlled by the UAV computing system during its controlled landing. In some embodiments, the controls outputs to alter the position and/or orientation of the UAV may be sent to a flight controller of the UAV. As illustrated, the example method 700 may return to block 705 to repeat a loop of the method 700 during the controlled navigation. For example, as the UAV descends particular optical markers may come into and/or out of the field of view or focus, which may require the UAV computing system to recalculate and/or determine its current relative orientation and/or location from the landing platform. The loop may end when UAV computing system determines that the UAV has successfully landed. The UAV computing system may determine that there has been a successfully landing using the optical vision techniques described herein and/or by using other input devices, such as, a gyroscope, accelerometer, magnetometer, an inertial navigation device, and/or some combination thereof.

In some embodiments, in addition to the optical landing techniques described herein, the UAV computing system may identify the location of the landing platform relative to the aircraft and builds a three dimensional map of the immediate environment. A map of the environment may allow the UAV computing system to determine the location of the landing platform even during those circumstances when the landing platform has gone out of view of the UAV's imager. Three dimensional reconstruction of the environment from imagery may also be capable of identifying dynamic obstacles and/or hazards in real- or near-time to enhance the visual landing process. The UAV computing system may dynamically avoid objects and/or hazards based on the constructed three-dimensional map. A three dimensional-map may be generated based on simultaneous localization and mapping, which constructs a representation of the surrounding environment from UAV sensors whose features are probabilistic and may become more accurate after repeated and/or iterative use. There may be two modes of operation. In the first mode, global positioning relative navigation may use satellite triangulation to localize the UAV relative to an Earth fixed coordinate system. The secondary mode of operation may use a landing platform relative coordinate system. A map of the environment may be built by placing the station platform at the origin. As imagery is systematically captured, the aircraft's position and orientation are updated in the context of this map. As additional features from the map are registered, it becomes possible to navigate from unstructured terrain imagery. Upon successful landing, the a priori estimate of the station platform location may be updated with the landed location and/or sent to the navigation system and/or server.

### Ground-Based Lighting System

As previously mentioned, ground and/or marker-based landings of UAVs may be difficult in low-light conditions. Also, it could be less costly or require fewer resources from the UAV to locate lighting on the ground. Thus, in some embodiments, light emitting devices and/or infrared wavelength lighting devices may be used on and/or near the landing platform to assist the UAV computing system to complete automated landings.

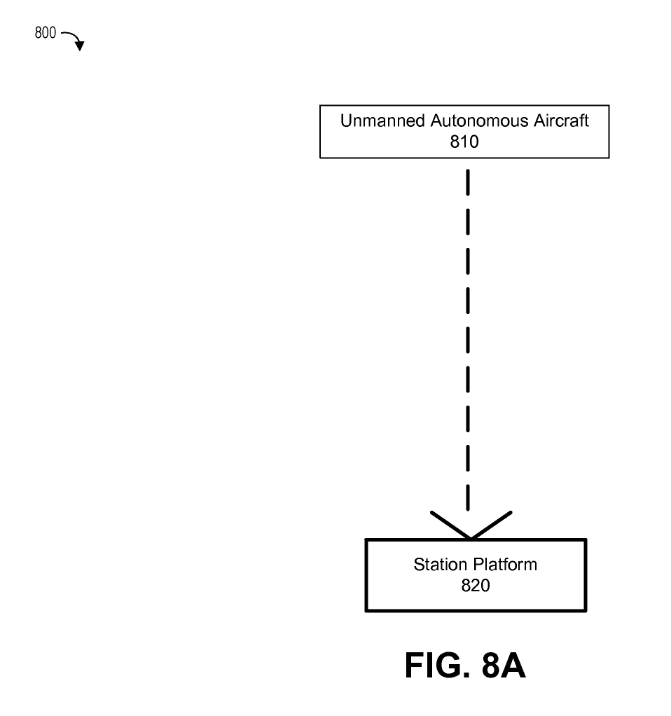

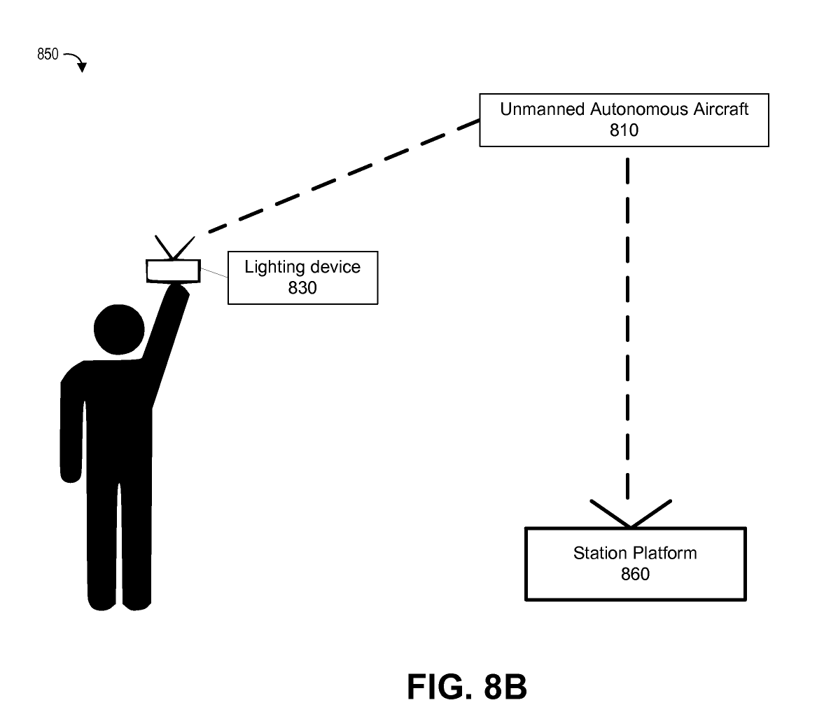

FIG. 8A is an example representation of a ground-based lighting system for automated visual landings, according to some embodiments of the present disclosure. Ground-based lighting system 800 may include a UAV 810 and a landing and/or station platform 820. Visible and/or infrared or ultraviolet wavelength light on station platform 820 may enhance the detectability of the optical markers on the landing platform. In other embodiments, light emitting devices may be embedded and/or used on landing and/or station platform 820 to allow a UAV computing system to automatically determine the UAV's relative location and orientation from the landing platform by detecting light coming from the landing platform. For example, station platform 820 may emit light at a modulated duty cycle and/or operating frequency to allow the UAV computing system to identify the landing platform and/or ground-based target.

FIG. 8B is another example representation of a ground-based lighting system for automated visual landings, according to some embodiments of the present disclosure. Ground-based lighting system 850 may include a UAV 810, a station platform 860, and a lighting device 830. For example, a user and/or operator may place lighting device 830 on landing platform 860 to provide a target for UAV 810 to land on. Lighting device 830 may be a user computing device, such as a smartphone or a tablet, a display of a user computing device, and/or any other electronic device capable of producing light. Similar to the station platform 820 of FIG. 8A that emitted light, lighting device 830 may emit light at a modulated duty cycle and/or operating frequency to allow the UAV computing system to identify the landing platform and/or ground-based target. For example, an application on a smartphone may be initiated that causes the display and/or screen of the smartphone to flash light at a predetermined frequency recognized by the UAV computing system. In certain embodiments, the lighting device 830 is the station platform 820.

In other embodiments, landing platform 820 may include one or more lights separate from or in addition to lighting device that is located separately from landing platform 820. For example, both lighting device 830 and landing platform 820 may emit light at one or more regulated frequencies detectable by input devices on UAV 810. Moreover, since lighting device 830 may be separate from landing platform 820, light emitted from lighting device 830 may provide the UAV computing system a point of reference to determine the relative location and/or orientation from lighting device 830 and the landing platform 820.

### Implementation Mechanisms

FIG. 9A is a diagram illustrating an example networking environment to implement a landing and/or navigation system, according to some embodiments of the present disclosure. The landing and/or navigation system comprises of one or more unmanned aerial vehicles 900A-900C, landing stations 960A-960C, a mobile application and/or user computing devices 901A-901C, a command server 930, and a network 922. UAVs 900A-900C may receive instructions and/or navigational information from one or more user computing devices 901A-901C and command server 930 via network 922. UAVs 900A-900C may further communicate with stations 960A-960C via network 922. Stations 960A-960C may include landing platforms. In certain embodiments, stations 960A-960C may not be connected to network 922 (not illustrated).

FIG. 9B depicts a general architecture of a computing system 900 (sometimes referenced herein as a UAV computing system) for autonomously landing a UAV. While the computing system 900 is discussed with respect to an on-board computing system of a UAV, computing system 900 and/or components of computing system 900 may be implemented by any of the devices discussed herein, such as UAVs 900A-900C, command server 930, landing station 960A-960C, and/or user computing device 901A-901C of FIG. 9A, for example. The general architecture of the UAV computing system 900 depicted in FIG. 9B includes an arrangement of computer hardware and software components that may be used to implement aspects of the present disclosure. The UAV computing system 900 may include many more (or fewer) elements than those shown in FIG. 9B. It is not necessary, however, that all of these elements be shown in order to provide an enabling disclosure. As illustrated, the UAV computing system 900 includes one or more hardware processors 904, a communication interface 918, a computer readable medium storage and/or device 910, one or more input devices 914A (such as an imager 914B, accelerometer, gyroscope, magnetometer, or other input device etc.), aircraft controller 950, one or more output devices 916A (such as a lighting device 916B, aircraft controls 916C), and memory 906, some of which may communicate with one another by way of a communication bus 902 or otherwise. The communication interface 918 may provide connectivity to one or more networks or computing systems. The hardware processor(s) 904 may thus receive information and instructions from other computing systems or services via the network 922. The hardware processor(s) 904 may also communicate to and from memory 906 and further provide output information to aircraft controller 950 to manipulate aircraft controls 916C, such as a propeller, for example.

The memory 906 may contain computer program instructions (grouped as modules or components in some embodiments) that the hardware processor(s) 904 executes in order to implement one or more embodiments. The memory 906 generally includes RAM, ROM and/or other persistent, auxiliary or non-transitory computer-readable media. The memory 906 may store an operating system that provides computer program instructions for use by the hardware processor(s) 904 in the general administration and operation of the computing system 900. The memory 906 may further include computer program instructions and other information for implementing aspects of the present disclosure. For example, in one embodiment, the memory 906 includes a visual landing module that detects optical markers and/or controls landing of the UAV. In addition, memory 906 may include or communicate with storage device 910. A storage device 910, such as a magnetic disk, optical disk, or USB thumb drive (Flash drive), etc., is provided and coupled to bus 902 for storing information, data, and/or instructions.

Memory 906 also may be used for storing temporary variables or other intermediate information during execution of instructions to be executed by hardware processor(s) 904. Such instructions, when stored in storage media accessible to hardware processor(s) 904, render computer system 900 into a special-purpose machine that is customized to perform the operations specified in the instructions.

In general, the word “instructions,” as used herein, refers to logic embodied in hardware or firmware, or to a collection of software modules, possibly having entry and exit points, written in a programming language, such as, but not limited to, Java, Lua, C, C++, or C#. A software module may be compiled and linked into an executable program, installed in a dynamic link library, or may be written in an interpreted programming language such as, but not limited to, BASIC, Perl, or Python. It will be appreciated that software modules may be callable from other modules or from themselves, and/or may be invoked in response to detected events or interrupts. Software modules configured for execution on computing devices by their hardware processor(s) may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware modules may be comprised of connected logic units, such as gates and flip-flops, and/or may be comprised of programmable units, such as programmable gate arrays or processors. The modules or computing device functionality described herein are preferably implemented as software modules, but may be represented in hardware or firmware. Generally, the instructions described herein refer to logical modules that may be combined with other modules or divided into sub-modules despite their physical organization or storage.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 910. Volatile media includes dynamic memory, such as main memory 906. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 902. Transmission media can also take the form of acoustic or light waves, such as those generated during radio-wave and infra-red data communications.

Computing system 900 also includes a communication interface 918 coupled to bus 902. Communication interface 918 provides a two-way data communication to network 922. For example, communication interface sends and receives electrical, electromagnetic or optical signals that carry digital data streams representing various types of information via cellular, packet radio, GSM, GPRS, CDMA, WiFi, satellite, radio, RF, radio modems, ZigBee, XBee, XRF, XTend, Bluetooth, WPAN, line of sight, satellite relay, or any other wireless data link.

Computing system 900 can send messages and receive data, including program code, through the network 922 and communication interface 918. A command server 930 might transmit instructions to and/or communicate with computing system 900 to navigate the UAV.

Computing system 900 may include a distributed computing environment including several computer systems that are interconnected using one or more computer networks. The computing system 900 could also operate within a computing environment having a fewer or greater number of devices than are illustrated in FIG. 9B.

Embodiments have been described in connection with the accompanying drawings. However, it should be understood that the figures are not drawn to scale. Distances, angles, etc. are merely illustrative and do not necessarily bear an exact relationship to actual dimensions and layout of the devices illustrated. In addition, the foregoing embodiments have been described at a level of detail to allow one of ordinary skill in the art to make and use the devices, systems, etc. described herein. A wide variety of variation is possible. Components, elements, and/or steps can be altered, added, removed, or rearranged. While certain embodiments have been explicitly described, other embodiments will become apparent to those of ordinary skill in the art based on this disclosure.

The preceding examples can be repeated with similar success by substituting generically or specifically described operating conditions of this disclosure for those used in the preceding examples.

Depending on the embodiment, certain acts, events, or functions of any of the methods described herein can be performed in a different sequence, can be added, merged, or left out altogether (e.g., not all described acts or events are necessary for the practice of the method). Moreover, in certain embodiments, acts or events can be performed concurrently, e.g., through multi-threaded processing, interrupt processing, or multiple processors or processor cores, rather than sequentially. In some embodiments, the algorithms disclosed herein can be implemented as routines stored in a memory device. Additionally, a processor can be configured to execute the routines. In some embodiments, custom circuitry may be used.

The various illustrative logical blocks and modules described in connection with the embodiments disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

Each of the processes, methods, and algorithms described in the preceding sections may be embodied in, and fully or partially automated by, code instructions or software modules executed by one or more computing systems or computer processors comprising computer hardware. The processes and algorithms may be implemented partially or wholly in application-specific circuitry. A software module can reside in RAM memory, flash memory, ROM memory, EPROM memory, EEPROM memory, registers, a hard disk, a removable disk, a CD-ROM, or any other form of computer-readable storage medium known in the art. An exemplary storage medium is coupled to a processor such that the processor can read information from, and write information to, the storage medium. In the alternative, the storage medium can be integral to the processor. The processor and the storage medium can reside in an ASIC. The ASIC can reside in a user terminal. In the alternative, the processor and the storage medium can reside as discrete components in a user terminal.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. Conjunctive language such as the phrase “at least one of X, Y and Z,” unless specifically stated otherwise, is otherwise understood with the context as used in general to convey that an item, term, etc. may be either X, Y or Z. Thus, such conjunctive language is not generally intended to imply that certain embodiments require at least one of X, at least one of Y and at least one of Z to each be present.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

While the above detailed description has shown, described, and pointed out novel features as applied to various embodiments, it will be understood that various omissions, substitutions, and changes in the form and details of the devices or algorithms illustrated can be made without departing from the spirit of the disclosure. Although the disclosure has been described in detail with particular reference to the embodiments disclosed herein, other embodiments can achieve the same results. Variations and modifications of the present disclosure will be obvious to those skilled in the art and it is intended to cover all such modifications and equivalents. As will be recognized, certain embodiments of the inventions described herein can be embodied within a form that does not provide all of the features and benefits set forth herein, as some features can be used or practiced separately from others. The scope of certain inventions disclosed herein is indicated by the appended claims rather than by the foregoing description. All changes which come within the meaning and range of equivalency of the claims are to be embraced within their scope. Accordingly, the present disclosure is not intended to be limited by the recitation of the various embodiments.

What is claimed is:

1. A landing system comprising:
a landing platform comprising first and second optical markers, wherein the first optical marker is larger than the second optical marker;
an unmanned aerial vehicle comprising:
an electronic camera; and
a hardware processor configured to execute computer-executable instructions to at least:
access a first image captured by the electronic camera, wherein the first image is of the first optical marker;
determine a first position of the unmanned aerial vehicle relative to the first optical marker based at least in part on the accessed first image;
cause a change in altitude of the unmanned aerial vehicle based at least in part on the determined first position;
access a second image captured by the electronic camera, wherein the second image is of the second optical marker;
determine a second position of the unmanned aerial vehicle relative to the second optical marker based at least in part on the accessed second image; and
cause a further change in altitude of the unmanned aerial vehicle based at least in part on the determined second position.

2. The landing system of claim 1, wherein the first position of the unmanned aerial vehicle is further determined based at least in part on using a 3D pose estimation algorithm, wherein input to the 3D pose estimation algorithm comprises data associated with the first image.

3. The landing system of claim 1, wherein the first optical marker is encoded with information regarding the relative location of the first optical marker with reference to the landing platform.

4. The landing system of claim 1, wherein at least one of the first or second optical markers comprises a rectilinear shape.

5. The landing system of claim 1, wherein the unmanned aerial vehicle further comprises a light emitting device, wherein the light emitting device is capable of illuminating at least one of the first or second optical markers.

6. The landing system of claim 1, wherein the landing platform is foldable.

7. A method for landing an unmanned aerial vehicle comprising:
accessing a first image, wherein the first image is of a first optical marker;
determining a first position of an unmanned aerial vehicle relative to the first optical marker based at least in part on the accessed first image;
providing first instructions to the unmanned aerial vehicle to change from the determined first position to a second position;
accessing a second image, wherein the second image is of a second optical marker, and wherein the second optical marker is a different size than the first optical marker;
determining a third position of the unmanned aerial vehicle relative to the second optical marker based at least in part on the accessed second image; and
providing second instructions to the unmanned aerial vehicle to change from the determined third position to a fourth position.

8. The method of claim 7, wherein the first position of the unmanned aerial vehicle is determined based at least in part on using a 3D pose estimation algorithm.

9. The method of claim 7, further comprising:
determining a relative position of the first optical marker with respect to the landing platform based at least in part on data encoded into the first optical marker.

10. The method of claim 7, wherein at least one of the first or second optical markers comprise a rectilinear shape.

11. The method of claim 7, wherein the unmanned aerial vehicle comprises a light emitting device, wherein the light emitting device is capable of illuminating at least one of the first or second optical markers.

12. A landing platform comprising:
a landing area, wherein the landing area is capable of supporting one or more unmanned aerial vehicles; and
a marking area comprising a first optical marker and a second optical marker, wherein the first optical marker is larger than the second optical marker, and wherein each optical marker of the first and second optical markers are detectable to enable a first unmanned aerial vehicle to determine its position relative to each respective optical marker of the first and second optical markers.

13. The landing platform of claim 12, further comprising a third optical marker, wherein the second optical marker is larger than the third optical marker, and wherein the third optical marker is detectable to enable the first unmanned aerial vehicle to determine its position relative to the third optical marker.

14. The landing platform of claim 12, wherein the marking area further comprises a printed surface.

15. The landing platform of claim 12, wherein the marking area further comprises the display of a user computing device.

16. The landing platform of claim 15, wherein the user computing device comprises a smartphone or a tablet.

17. The landing platform of claim 12, wherein at least one of the first or second optical markers comprises a rectilinear shape.

18. The landing platform of claim 12, wherein at least one of the first or second optical markers comprises a monochromatic color.

19. The landing platform of claim 12, further comprising a light emitting device.

20. The landing platform of claim 12, wherein at least one of the first or second optical markers comprises a one unit first border, a two unit second border, and a five unit by five unit pattern.
